(19) United States
(12) Patent Application Publication
(10) Pub. No.: US 2006/0033700 A1
(43) Pub. Date: Feb. 16, 2006

(54) Control system display screen for an appliance

(76) Inventors: Robert A. Lewis, Alta Loma, CA (US); Joey J. Kitabayashi, San Dimas, CA (US); David A. Wolff, St. Charles, IL (US)

Correspondence Address: FULBRIGHT AND JAWORSKI LLP, 555 S. FLOWER STREET, 41ST FLOOR, LOS ANGELES, CA, 90071, US

(21) Appl. No.: 11/097,794

(22) Filed: Mar. 31, 2005

Related U.S. Application Data
(60) Provisional application No. 60/559,291, filed on Apr. 2, 2004.

(51) Int. Cl. G09G 3/36

(52) U.S. Cl. 345/102

(57) ABSTRACT

A control system display screen for appliances is provided with a backlighted screen for which the color may be varied. The backlighted screen is provided with a multiplicity of groups of three liquid crystal devices (“LCD”) in which each group has LCDs of three different colors with red, green and blue being the preferred colors. The intensity of the light emitted from each set of LCDs of a given color may be varied by a control manipulated by the operator to thereby provide a backlighted screen of virtually any desired color that may be created by mixing those three colors.

Priority for this nonprovisional patent application is claimed on the basis of and from U.S. Provisional Patent Application No. 60/559,291, filed Apr. 2, 2004.

The present invention relates to display screens for the control systems of kitchen appliances and, in particular, to a backlighted display screen that is variable in color by the user.

Many modern kitchen appliances have display screens for the user to observe the operating control specifications that the user has set for the appliance. For example, for ovens a user may select the mode of cooking, such as, bake, broil, convection, etc., the temperature for cooking, and the time duration for cooking, and then the selected mode, temperature and time are displayed. Normally, the display is black-on-white, white-on-black or a specific color as either the background or the letters and numerals.

It is an object of the present invention to provide a control system display screen for appliances in which the screen is backlighted by a multiplicity of groups of liquid crystal devices (“LCD”) where each group has two or more different colors and the intensity of each color may be varied for varying the color of the backlighted screen. A more specific object of this invention is to provide such a display screen wherein LCDs of three different colors are provided in each group and the intensity of each of the three colors may be varied from zero to maximum intensity. A still further object of this invention is to provide such a display screen in which the three colors of LCDs are red, green and blue.

Other objects and advantages of the present invention will appear to those skilled in the art from the following description of a preferred embodiment in connection with the drawings, wherein:

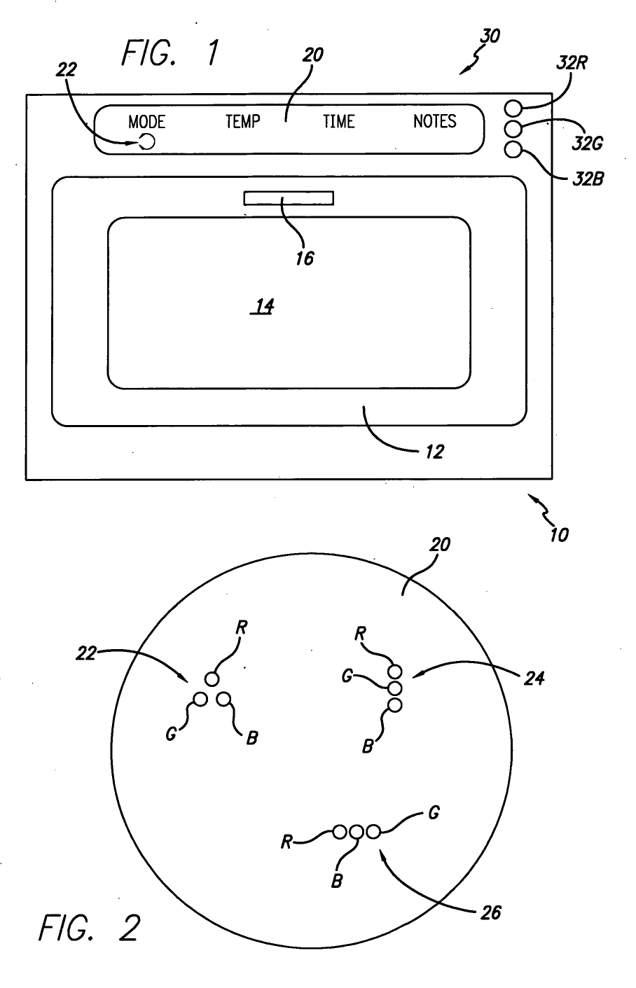

FIG. 1 is an elevation view of the front of a wall oven incorporating the control system display screen of the present invention; and

FIG. 2 is an enlarged diagrammatic view of the display screen taken, for example, on circle 2-2 in FIG. 1.

Referring more particularly to FIG. 1, a wall-mounted type of domestic kitchen oven 10 is shown as an example of the application of the present invention but it will readily appear to those skilled in the art that the invention may be used with any appliance. The oven 10 has a door 12 with a glass panel 14 and handle 16 on the front of the oven. Above the door 12 is a control system panel 20 for the oven that may have legends thereon for the different control operations which may include, as shown, MODE, TEMP, TIME and NOTES or any other legends for the controls. The appropriate area of control system panel 20 is backlighted with the selected words and/or numbers of the control parameters (Mode, Temp, Time, Notes, etc.) displayed in black lettering and numerals or clear lettering and numerals against a dark background, similar to other display screens.

Referring now to FIG. 2, a substantially enlarged small portion of the panel 20 is illustrated diagrammatically for purposes of this description. The entire backlighted screen portion of the panel 20 is comprised of an array of individual groups of two or more liquid crystal devices (“LCDs”) of different colors or any other light emitting device of similar size and controllability. At present, it is preferred to use three different colors of LCDs, namely, red, green and blue, but only two LCDs or more than three LCDs of different colors may be used in the present invention. The three different colors of LCDs may be arranged in any desired pattern in each group. For example, group 22 shows the three different colors of LCDs arranged in a triangle, group 24 shows the three different colors of LCDs arranged in a vertical line, and group 26 shows the three different colors of LCDs arranged in a horizontal line, with the colors represented by R for red, G for green and B for blue. The groups of colors may be arranged in any order and may be varied throughout the screen but normally would be in the same established pattern throughout the screen 20. A minimal spacing is provided between each group of LCDs to provide a continuous appearing letter or numeral when the multiplicity of LCDs are activated.

A color control, generally designated 30, is provided for varying the intensity of the light emitted by each of the colors of LCDs which may be part of the display screen panel 20 or separate, as shown. For convenience of description of the invention, the control 30 is shown with three knobs or buttons 32R, 32G and 32B that are individually used for varying the intensity of the red LCDs, green LCDs and blue LCDs, respectively, but the color controls may be part of a touch-screen portion of panel 20. Each of the separate control knobs or buttons 32 is capable of varying the intensity of the light emitted by that color of LCDs over a range of sixteen coarse and sixteen fine adjustments by applying a hexadecimal control system. Thus, the intensity of light emitted for each color is variable over 256 settings (16 times 16). Since each of the three colors are variable separately in that degree, the total variations available exceed 16 million (256×256×256) whereby the color selectable by the user is virtually unlimited. As a practical matter, a smaller range of adjustments may be provided for each color which will still provide a wide range of color variations.

Thus, it will appear to those skilled in the art that the present invention provides a very attractive display screen for appliances with the ability of the user to personally select the color of the display screen and vary that color in any manner desired. While a specific preferred embodiment with a specific number of colors and range of controls has been described, it is to be understood that the invention is not limited to the specific embodiment.

1. A control system display screen for an appliance, comprising,
a backlighted screen having a multiplicity of groups of two or more LCDs of different colors arranged to cover the entire area of said screen to be backlighted,
a control for varying the intensity of the light emitted by each color of LCDs, and
a separate set of LCDs for displaying indicia of the operating conditions of the appliance.

2. The control system display screen of claim 1, wherein there are three LCDs in each said group of the colors red, green and blue.

3. The control system display screen of claim 1, wherein the intensity of each color of LCDs is variable from zero to a maximum emission amount for that LCD.

4. The control system display screen of claim 3, wherein the intensity of each color of LCDs is variable in sixteen coarse steps and sixteen fine steps.

5. The control system display screen of claim 1, wherein said separate set of LCDs for displaying indicia are operable to selectively display black or clear indicia.

6. A control system display screen for an appliance, comprising,
a backlighted screen having a multiplicity of groups of two or more LCDs of different colors arranged to cover the entire area of said screen to be backlighted, and
a control for varying the intensity of the light emitted by each color of LCDs.

7. The control system display screen of claim 6, wherein there are three LCDs of the colors red, green and blue in each said group.

8. The control system display screen of claim 6, wherein the intensity of each color of LCDs is variable from zero to a maximum emission amount for that LCD.

9. The control system display screen of claim 8, wherein the intensity of each color of LCDs is variable in sixteen coarse steps and sixteen fine steps.

10. The control system display screen of claim 6, wherein there are 2 LCDs of different colors in each said group.
